(19) United States
(12) Patent Application Publication
(10) Pub. No.: US 2024/0391022 A1
(43) Pub. Date: Nov. 28, 2024

(54) WELD STRUCTURES CONFIGURED FOR JOINING MATERIALS

(71) Applicant: GM GLOBAL TECHNOLOGY OPERATIONS LLC, Detroit, MI (US)

(72) Inventors: Junjie MA, Novi, MI (US); Ying LU, Novi, MI (US); Hui-ping WANG, Troy, MI (US); Joshua Lee SOLOMON, Berkley, MI (US); Baixuan YANG, Canton, MI (US)

(21) Appl. No.: 18/322,973

(22) Filed: May 24, 2023

(51) Int. Cl. B23K 26/08; B23K 26/21

(52) U.S. Cl. CPC B23K 26/0869; B23K 26/21; B23K 2101/006

(57) ABSTRACT

A system for joining a first part and a second part together with a weld structure. The system includes: a welding element configured to form the weld structure between the first part and the second part; and a control module configured to operate the welding element to form the weld structure. The weld structure includes: a first curved end; a second curved end; a connecting portion connecting the first curved end and the second curved end; a first curved crown spaced apart from the first curved end and concentric with the first curved end; and a second curved crown spaced apart from the second curved end and concentric with the second curved end. The first curved end, the second curved end, and the connecting portion are between the first curved crown and the second curved crown.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to weld structures for joining materials.

Welding is a fabrication process that joins materials, such as metals or thermoplastics. Welding uses high heat to melt the materials together. As the materials cool, they become fused together. The strength of the weld depends on a number of factors, including the weld structure.

### SUMMARY

In various features, the present disclosure includes a system for joining a first part and a second part together with a weld structure. The system includes: a welding element configured to form the weld structure between the first part and the second part; and a control module configured to operate the welding element to form the weld structure. The weld structure includes: a first curved end; a second curved end; a connecting portion connecting the first curved end and the second curved end; a first curved crown spaced apart from the first curved end and concentric with the first curved end; and a second curved crown spaced apart from the second curved end and concentric with the second curved end. The first curved end, the second curved end, and the connecting portion are between the first curved crown and the second curved crown.

In further features, the first part and the second part are components of a vehicle battery support tray.

In further features, the first part and the second part are components of a vehicle body.

In further features, the welding element is one of a laser welding element, an electron beam welding element, and an arc welding element.

In further features, the first part and the second part each include at least one of zinc coated steel, steel, aluminum, copper, nickel, titanium, high entropy alloys (HEAs), and a polymer.

In further features, the first curved end and the second curved end have an identical first arc radius; the first curved crown and the second curved crown have an identical second arc radius; and the first curved crown is spaced apart from the first curved end at a first distance and the second curved crown is spaced apart from the second curved end at a second distance that is the same as the first distance.

In further features, the first curved crown is spaced apart from the first curved end at 10 mm or less, and the second curved crown is spaced apart from the second curved end at 10 mm or less.

In further features, the first curved crown is spaced apart from the first curved end at 2 mm-6 mm, and the second curved crown is spaced apart from the second curved end at 2 mm-6 mm.

In further features, the first curved end and the second curved end each have a first arc radius of 2.5 mm; and the first curved crown and the second curved crown each have a second arc radius of 5.5 mm.

In further features, the connecting portion is linear.

In further features, a maximum chord length of each of the first curved end, the second curved end, the first curved crown, and the second curved crown is the same.

In further features, a maximum chord length of the first curved end is less than a maximum crown chord length of the first curved crown.

In further features, each one of the first curved end and the second curved end extend along a curve of at least 180°.

The present disclosure further includes, in various features, a weld structure joining a first part to a second part. The weld structure includes: a first curved end; a second curved end; a connecting portion connecting the first curved end and the second curved end; a first curved crown spaced apart from the first curved end and concentric with the first curved end; and a second curved crown spaced apart from the second curved end and concentric with the second curved end. The first curved end and the second curved end have an identical first arc radius. The first curved crown and the second curved crown have an identical second arc radius. The first curved crown is spaced apart from the first curved end at a first distance and the second curved crown is spaced apart from the second curved end at a second distance that is the same as the first distance.

In further features, a maximum chord length of each of the first curved end, the second curved end, the first curved crown, and the second curved crown is the same.

In further features, a maximum chord length of the first curved end is less than a maximum crown chord length of the first curved crown.

The resent disclosure further includes, in various features a weld structure joining a first part to a second part. The weld structure includes: a first curved end; a second curved end; a connecting portion connecting the first curved end and the second curved end; a first curved crown spaced apart from the first curved end and concentric with the first curved end; and a second curved crown spaced apart from the second curved end and concentric with the second curved end. The first curved end and the second curved end have an identical first arc radius and an identical first maximum chord length. Both the first curved end and the second curved end extend at least 180°. The first curved crown and the second curved crown have an identical second arc radius and an identical second maximum chord length. An entirety of the first curved crown is spaced apart from the first curved end at a first distance and an entirety of the second curved crown is spaced apart from the second curved end at a second distance that is the same as the first distance.

In further features, the first maximum chord length and the second maximum chord length are the same.

In further features, the first maximum chord length is less than the second maximum chord length.

In further features, the first curved end and the first curved crown are concentric about a first radial center; the second curved end and the second curved crown are concentric about a second radial center; and the first radial center and the second radial center are aligned along a line extending parallel to the connecting portion.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates a system for joining a first part and a second part together with an exemplary weld structure in accordance with the present disclosure;

FIG. 2 is a perspective view of an exemplary automotive application for the weld structure; and

FIG. 3 illustrates area 3 of FIG. 2 in additional detail;

FIG. 4 illustrates an exemplary weld structure of the present disclosure configured as a staple weld with a full crown;

FIG. 5 illustrates an additional exemplary weld structure of the present disclosure configured as a staple weld with a simple crown;

FIG. 6 illustrates another exemplary weld structure of the present disclosure configured as a c-weld with a full crown; and

FIG. 7 illustrates an exemplary weld structure of the present disclosure configured as a c-weld with a simple crown.

In the drawings, reference numbers may be reused to identify similar and/or identical elements.

### DETAILED DESCRIPTION

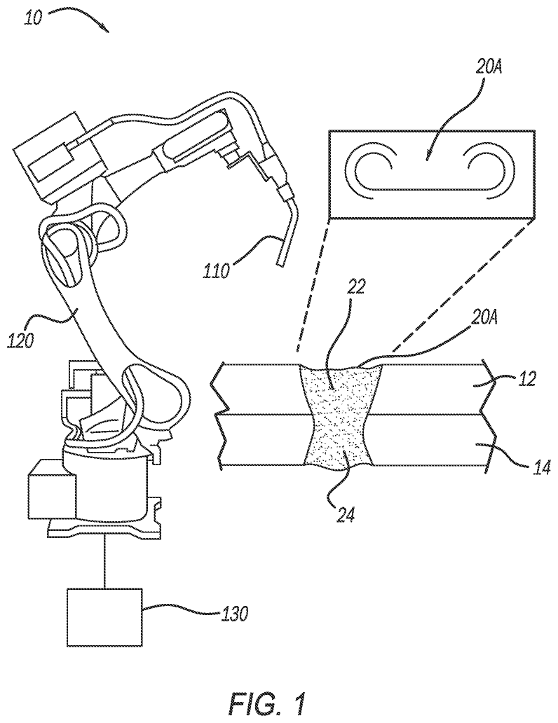

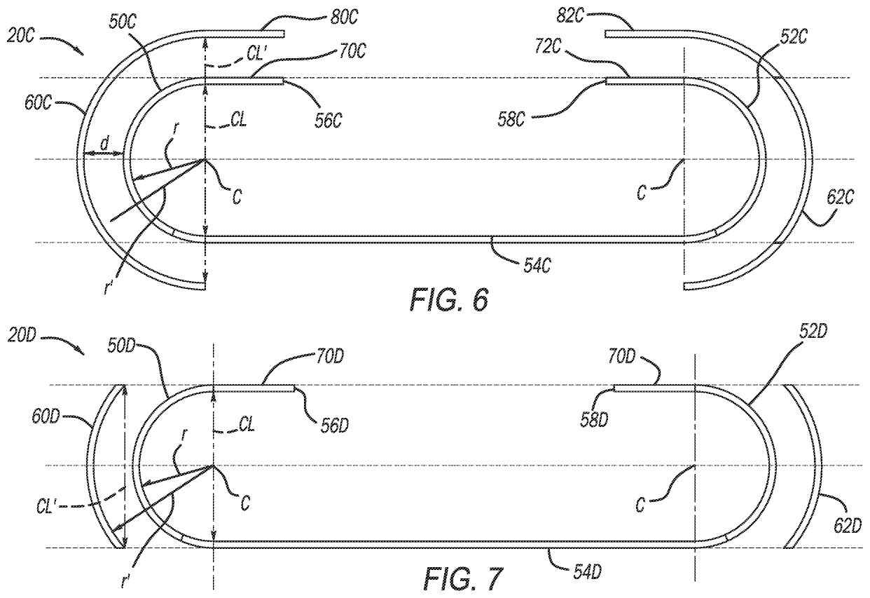

FIG. 1 illustrates a system 10 for joining a first part 12 and a second part 14 with a weld. The weld generally includes a first welded area 22 of the first part 12 and a second welded area 24 of the second part 14. The first welded area 22 and the second welded area 24 have been heated above the melting points of the first part 12 and the second part 14, and then allowed to cool. Upon cooling, the first welded area 22 and the second welded area 24 become fused together to secure the first part 12 and the second part 14 together. In the example of FIG. 1, the weld is formed to have a weld structure 20A. But the weld may be formed to have any of the weld structures described herein, such as, but not limited to, the following: the weld structure 20A (FIGS. 1-4); a weld structure 20B (FIG. 5); a weld structure 20C (FIG. 6); or a weld structure 20D (FIG. 7).

The weld structures 20A-20D may be formed by any suitable welding process, such as, but not limited to, laser welding, electron beam welding, arc welding, etc. FIG. 1 illustrates an exemplary welding element 110 for forming the weld structures 20A-20D. The welding element 110 may be maneuvered in any suitable manner, such as with a robotic arm 120. Alternatively, the welding element 110 may be held stationary, and the first part 12 and second part 14 may be moved opposite to the welding element 110. The welding element 110 is controlled by a control module 130 to form the weld structures 20A-20D. The control module 130 is configured to maneuver the robotic arm 120 and/or any actuatable member on which the first and second parts 12, 14 are seated. The welding element 110 may also be maneuvered manually. In the case that the welding element 110 is a laser scanner including two rotating Galvo-mirrors, the weld structures 20A-20D can be formed with the rotations of the two Galvo-mirrors, which move the laser beam along the weld structures 20A-20D to join the first part 12 to the second part 14.

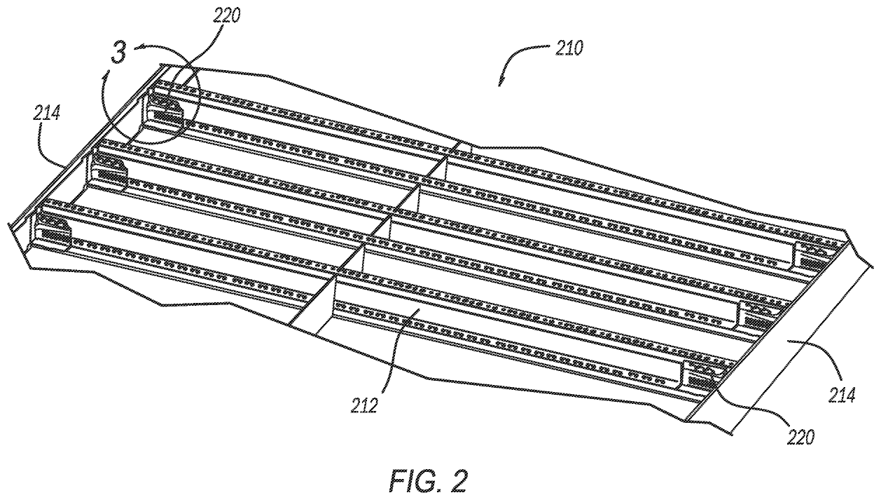

The first part 12 and the second part 14 may be made of the same material, or different materials. For example, each one of the first part 12 and the second part 14 may be made of any suitable metallic material, zinc coated steel, steel, aluminum, copper, Ni, Ti, high entropy alloys (HEAs), or a polymer. The first and second parts 12 and 14 may be any parts suitable to be welded together. For example, and with reference to FIG. 2, the first part 12 and the second part 14 may be components of a battery support tray 210 for a vehicle. The first part 12 and the second part 14 may also be components of a vehicle body, such as a “body in white.” The weld structures 20A-20D may be used to join parts for use in any other suitable application as well, such as, but not limited to, aerospace (e.g., joining fuselage components for wing components), ship building (e.g., joining components of a ship hull), medical applications, etc.

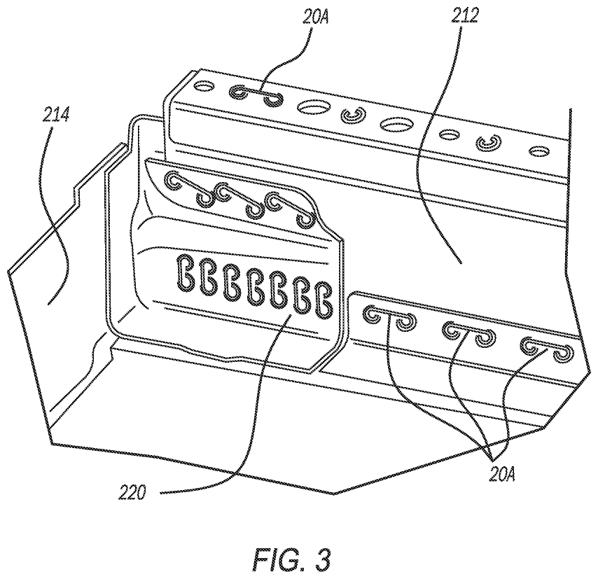

With respect to the exemplary battery support tray 210 of FIG. 2, the tray 210 includes a plurality of crossbeams 212 extending between sidewalls 214. The crossbeams 212 are secured to the tray 210 with a plurality of the weld structures 20A-20D. Any of the weld structures 20A-20D may be used depending on the amount of space available at the weld location. The weld structures of the tray 210 may all have the same structure, or a mixture of two or more of the weld structures 20A-20D may be used. With continued reference to FIG. 2 and additional reference to FIG. 3, the weld structures 20A (or any of the other weld structures 20B-20D) may be used to weld brackets 220 to the crossbeams 212 and the sidewalls 214 to secure the crossbeams 212 in place.

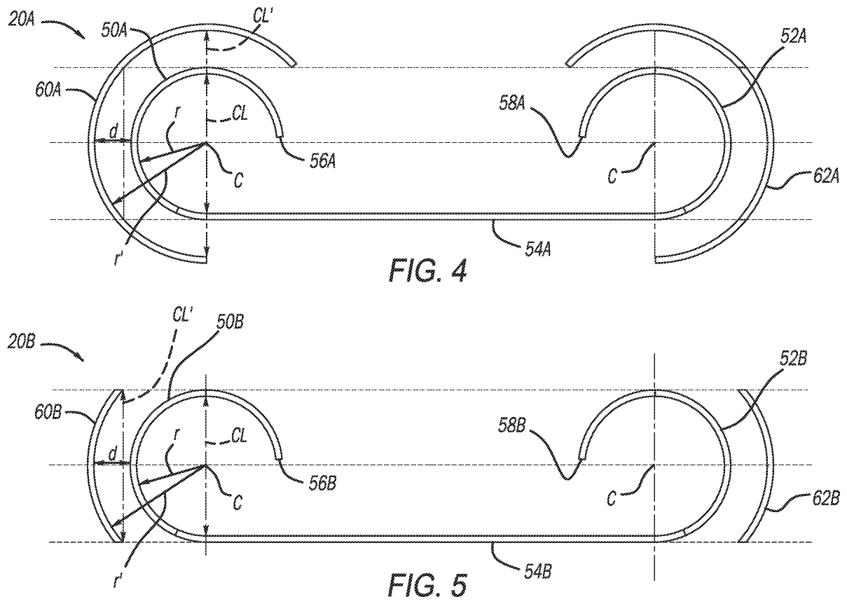

With reference to FIGS. 4-7, the weld structures 20A-20D will now be described in additional detail. Starting with FIG. 4, and the weld structure 20A is a staple weld with a full crown. The weld structure 20A includes a first curved end 50A and a second curved end 52A. The first and second curved ends 50A, 52A are on opposite ends of the weld structure 20A. The first and second curved ends 50A, 52A are connected by a connecting portion 54A. The connecting portion 54A may be linear as illustrated, or configured in any other suitable manner.

The first curved end 50A is curved about a center point C. The first curved end 50A is generally an arc that extends less than 360°. In the example illustrated, the arc of the first curved end 50A extends about 270° around the center C from the connecting portion 54A. Because the first curved end 50A does not extend 360°, an open area or gap is defined between a terminus 56A and the connecting portion 54A. The gap generally faces the second curved end 52A. Like the first curved end 50A, the second curved end 52A defines a gap between a terminus 58A and the connecting portion 54A. This gap of the second curved end 52A generally faces the gap defined at the first curved end 50A. The second curved end 52A is the same as, or substantially similar to, the first curved end 50A. Thus, the description of the first curved end 50A also applies to the second curved end 52A. The center C of the first curved end 50A and the center C of the second curved end 52A are aligned along a line extending parallel to the connection portion 54A.

The weld structure 20A further includes a first curved crown 60A and a second curved crown 62A. The first curved crown 60A is spaced apart evenly from the first curved end 50A and is concentric with the first curved end 50A. Likewise, the second curved crown 62A is spaced apart evenly from the second curved end 52A and is concentric with the second curved end 52A.

The first curved crown 60A extends more than 180° about the center C, but less than 360°. The first curved crown 60A is outboard of the first curved end 50A, and uniformly spaced apart from the first curved end 50A at 10 mm or less. More specifically, the first curved crown 60A may be spaced apart from the first curved end 50A anywhere from 2 mm to 6 mm.

The first curved end 50A may have any suitable arc radius r, such as 2.5 mm, for example. The first curved crown 60A may have any suitable arc radius r′, such as 5.5 mm. The first curved end 50A may have any suitable maximum chord length CL, and the first curved crown 60A may have any suitable maximum chord length CL′. The maximum chord CL′ is greater than the maximum chord length CL of the first curved end 50A.

The dimensions and relative positions of the second curved end 52A and the second curved crown 62A are the same as, or substantially similar to, the dimensions and relative positions of the first curved end 50A and the first curved crown 60A respectively. Thus, the dimensions and relative positioning of the first curved end 50A and the first curved crown 60A described above also apply to the second curved end 52A and the second curved crown 62A.

With reference to FIG. 5, the weld structure 20B including a staple weld and a simple crown will now be described. Features of the weld structure 20B that are the same as, or similar to, features of the weld structure 20A are identified in FIG. 5 with the same reference numbers, but are designated with the letter “B” instead of “A.” The description of the weld structure 20A also applies to the weld structure 20B except for the differences identified below.

Like the weld structure 20A, the weld structure 20B includes the first curved end 50B, the second curved end 52B, and the connecting portion 54B. The description of the first curved end 50A, the second curved end 52A, and the connecting portion 54A also describes the first curved end 50B, the second curved end 52B, and the connecting portion 54B. The only substantial difference between the weld structure 20A and the weld structure 20B is that the first curved crown 60B and the second curved crown 62B are each shorter than the first curved crown 60A and the second curved crown 62A. More specifically, first curved crown 60B and the second curved crown 62B each extend less than 180°, and each have a maximum chord length CL′ that is less than the maximum chord length CL′ of the first curved crown 60A and the second curved crown 60B. The maximum chord length CL′ of the first curved crown 60B is the same as the maximum chord length CL of the first curved end 50B. And the maximum chord length of the second curved crown 62B is the same as the maximum chord length CL of the second curved end 52B. Thus, for the weld structure 20B, the first curved end 50B, the second curved end 52B, the first curved crown 60B, and the second curved crown 62B all have the same maximum chord length. To save space, the first curved crown 60B is positioned relative to the first curved end 50B such that the first curved crown 60B does not extend beyond the first curved end 50B. Likewise, the second curved crown 62B does not extend beyond the second curved end 52B.

With reference to FIG. 6, the weld structure 20C including a C-weld and a full crown will now be described. Features of the weld structure 20C that are the same as, or similar to, features of the weld structures 20A, 20B are identified in FIG. 6 with the same reference numbers, but are designated with the letter “C.” The description of the weld structures 20A and 20B also applies to the weld structure 20C except for the differences identified below.

The weld structure 20C includes a first curved end 50C, a second curved end 52C and a connecting portion 54C, which connects the first and second curved ends 50C, 52C together. The first curved end 50C extends from the connecting portion 54C 180° to a first linear tale 70C. Likewise, the second curved end 52C extends from the connecting portion 54C 180° to a second linear tail 72C. The first linear tail 70C terminates at first terminus 56C and the second linear tail 72C terminates at second terminus 58C. The first terminus 56C is opposite to the second terminus 58C.

The first curved crown 60C curves 180° about the first curved end 50C. A linear crown tail 80C extends from the first curved crown 60C opposite to, and parallel to, the first linear tail 70C. Likewise, the second curved crown 62C extends 180° about the second curved end 52C. Extending from the second curved crown 62C is a linear crown tail 82C. The linear crown tail 82C extends opposite to, and parallel to, the second linear tail 72C. The first curved crown 60C has a maximum chord length CL′ that is greater than a maximum chord length CL of the first curved end 50C. Likewise, the second curved crown 62C has a maximum chord length that is greater than a maximum chord length of the second curved end 52C.

With reference to FIG. 7, the weld structure 20D including a C-weld and a simple crown will now be described. Features of the weld structure 20D that are the same as, or similar to, features of the weld structures 20A, 20B, 20C are identified in FIG. 7 with the same reference numbers, but are designated with the letter “D.” The description of the weld structures 20A, 20B, 20C also applies to the weld structure 20D except for the differences identified below.

With reference to FIG. 7, the weld structure 20D is substantially similar to the weld structure 20C, except for the lengths of the first and second curved crowns 60D and 62D. Specifically, unlike the weld structure 20C, the first curved crown 60D has a maximum chord length CL′ that is the same as the maximum chord length CL of the first curved end 50D. Likewise, the second curved crown 62D has a maximum chord length that is the same as the maximum chord of the second curved end 52D. The first curved crown 60D is positioned such that it does not extend outward wider than the first curved end 50D. Likewise, the second curved crown 62D is positioned such that it does not extend outward wider than the second curved end 52D.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for joining a first part and a second part together with a weld structure, the system comprising:
a welding element configured to form the weld structure between the first part and the second part; and
a control module configured to operate the welding element to form the weld structure to include the following:
a first curved end;
a second curved end;
a connecting portion connecting the first curved end and the second curved end;
a first curved crown spaced apart from the first curved end and concentric with the first curved end; and
a second curved crown spaced apart from the second curved end and concentric with the second curved end;
wherein the first curved end, the second curved end, and the connecting portion are between the first curved crown and the second curved crown.

2. The system of claim 1, wherein the first part and the second part are components of a vehicle battery support tray.

3. The system of claim 1, wherein the first part and the second part are components of a vehicle body.

4. The system of claim 1, wherein the welding element is one of a laser welding element, an electron beam welding element, and an arc welding element.

5. The system of claim 1, wherein the first part and the second part each include at least one of zinc coated steel, steel, aluminum, copper, nickel, titanium, high entropy alloys (HEAs), and a polymer.

6. The system of claim 1, wherein:
the first curved end and the second curved end have an identical first arc radius;
the first curved crown and the second curved crown have an identical second arc radius; and
the first curved crown is spaced apart from the first curved end at a first distance and the second curved crown is spaced apart from the second curved end at a second distance that is the same as the first distance.

7. The system of claim 1, wherein the first curved crown is spaced apart from the first curved end at 10 mm or less, and the second curved crown is spaced apart from the second curved end at 10 mm or less.

8. The system of claim 1, wherein the first curved crown is spaced apart from the first curved end at 2 mm-6 mm, and the second curved crown is spaced apart from the second curved end at 2 mm-6 mm.

9. The system of claim 1, wherein:
the first curved end and the second curved end each have a first arc radius of 2.5 mm; and
the first curved crown and the second curved crown each have a second arc radius of 5.5 mm.

10. The system of claim 1, wherein the connecting portion is linear.

11. The system of claim 1, wherein a maximum chord length of each of the first curved end, the second curved end, the first curved crown, and the second curved crown is the same.

12. The system of claim 1, wherein a maximum chord length of the first curved end is less than a maximum crown chord length of the first curved crown.

13. The system of claim 1, wherein each one of the first curved end and the second curved end extend along a curve of at least 180°.

14. A weld structure joining a first part to a second part, the weld structure comprising:
a first curved end;
a second curved end;
a connecting portion connecting the first curved end and the second curved end;
a first curved crown spaced apart from the first curved end and concentric with the first curved end; and
a second curved crown spaced apart from the second curved end and concentric with the second curved end;
wherein:
the first curved end and the second curved end have an identical first arc radius;
the first curved crown and the second curved crown have an identical second arc radius; and
the first curved crown is spaced apart from the first curved end at a first distance and the second curved crown is spaced apart from the second curved end at a second distance that is the same as the first distance.

15. The weld structure of claim 14, wherein a maximum chord length of each of the first curved end, the second curved end, the first curved crown, and the second curved crown is the same.

16. The weld structure of claim 14, wherein a maximum chord length of the first curved end is less than a maximum crown chord length of the first curved crown.

17. A weld structure joining a first part to a second part, the weld structure comprising:
a first curved end;
a second curved end;
a connecting portion connecting the first curved end and the second curved end;
a first curved crown spaced apart from the first curved end and concentric with the first curved end; and
a second curved crown spaced apart from the second curved end and concentric with the second curved end;
wherein:
the first curved end and the second curved end have an identical first arc radius and an identical first maximum chord length;
both the first curved end and the second curved end extend at least 180°;
the first curved crown and the second curved crown have an identical second arc radius and an identical second maximum chord length; and
an entirety of the first curved crown is spaced apart from the first curved end at a first distance and an entirety of the second curved crown is spaced apart from the second curved end at a second distance that is the same as the first distance.

18. The weld structure of claim 17, wherein the first maximum chord length and the second maximum chord length are the same.

19. The weld structure of claim 17, wherein the first maximum chord length is less than the second maximum chord length.

20. The weld structure of claim 17, wherein:
the first curved end and the first curved crown are concentric about a first radial center;
the second curved end and the second curved crown are concentric about a second radial center; and
the first radial center and the second radial center are aligned along a line extending parallel to the connecting portion.
